(19) United States
(12) Patent Application Publication
(10) Pub. No.: US 2014/0190761 A1
(43) Pub. Date: Jul. 10, 2014

(54) STEERING SYSTEM IN A VEHICLE COMPRISING AN ELECTRIC SERVOMOTOR

(71) Applicant: ZF LENKSYSTEME GMBH, Schwaebisch Gmuend (DE)

(72) Inventor: Gerd REIMANN, Abstatt (DE)

(73) Assignee: ZF LENKSYSTEME GMBH, Schwaebisch Gmuend (DE)

(21) Appl. No.: 14/049,481

(22) Filed: Oct. 9, 2013

(30) Foreign Application Priority Data
Jan. 10, 2013 (DE) 10 2013 100 187.4

(51) Int. Cl. B62D 5/04

(52) U.S. Cl. CPC B62D 5/0409
USPC 180/444

(57) ABSTRACT

A steering system in a vehicle comprising an electric servomotor which includes a switching gearbox that is integrated into the steering shaft and has a switching actuator wherein a less direct gear ratio is presented when the switching actuator is de-energized than when it is energized.

### BACKGROUND OF THE INVENTION

The invention relates to a steering system in a vehicle comprising an electric servomotor for generating a servo torque that supports the steering motion.

DE 100 32 120 A1 describes a steering system for a vehicle comprising electric steering assistance (EPS, electric power steering). The steering assistance system comprises an electric servomotor which is used to generate a servo torque for supporting the steering motion of the driver.

In the event of a failure of the electric servomotor, the supporting servo torque is also lost, and thus the driver is forced to apply a considerably higher steering torque to be able to implement the desired steering motion. If the servomotor fails during a steering motion, the driver is required to apply an increased steering torque at a moment's notice to be able to complete the steering process.

It is the object of the invention to reduce the steering torque to be applied by the driver in a steering system in the event of a failure of an electric servomotor.

### SUMMARY OF THE INVENTION

The steering system according to the invention is installed in vehicles in order to adjust the steerable wheels. The steering system comprises a steering shaft by way of which the driver specifies a desired steering angle using the steering wheel. The steering shaft is connected to a steering gearbox by way of which the steering angle is converted into a movement of a steering linkage and into a wheel steering angle of the steerable wheels. The steering system is equipped with an electric servomotor (electric power steering, EPC) which is coupled to the steering gearbox and supplies a supporting steering torque to the steering system.

So as to prevent, or at least mitigate, an increase in the steering torque that must be applied by the driver in the event of a failure of the electric servomotor, a switching gearbox is integrated into the steering shaft of the steering system, the switching gearbox being provided with a switching actuator, the actuation of which varies the gear ratio in the transmission path between the steering wheel and steering gearbox. The switching gearbox is designed so that a less direct gear ratio is present in the de-energized state of the associated switching actuator than in the energized state of the switching actuator. The less direct gear ratio is associated with a reduced manual or steering torque, which the driver has to apply via the steering wheel to set the desired steering angle. The less direct gear ratio in the de-energized state of the switching actuator also constitutes an additional safely measure, because in the event of the electric onboard power system, which affects both the electric servomotor and the electric switching actuator, a lower steering torque is ensured than with embodiments from the prior art comprising no switching gearbox in the steering shaft. The steering torque may optionally be adjusted by an appropriate increase in the gear ratio so that, in the event of a failure of the electric servo assistance, the driver has to apply the same manual torque as with servo assistance.

In the energized state, the switching gearbox advantageously has a gear ratio of 1:1, so that in this state, which corresponds to a functional electric servomotor, the influence of the switching gearbox is imperceptible in the steering system. Only in the de-energized state does a change in the gear ratio to less direct gearing occur, for example with a gear ratio of at least 1:2, and preferably 1:4, which is associated with a corresponding reduction of the steering torque that must be applied by the driver.

So as to compensate for the higher steering turning angle that is required as a result of the less direct gear ratio, which must be applied by the driver in the de-energized state of the switching gearbox or switching actuator, the steering system is advantageously provided with a superimposing gearbox, by way of which a superimposed steering angle can be superimposed on the steering angle specified by the driver. The superimposed steering angle modifies the steering angle generated by the driver in a positive or negative direction, so that, depending on the setting of the superimposing gearbox, a larger, equally large or smaller steering angle arrives at the steering gearbox than is specified by the driver. The de-energizing of the switching gearbox and the attendant less direct gear ratio advantageously also adjusts the superimposing gearbox, and more particularly to the effect that the changed gear ratio of the switching gearbox is at least partially, and preferably completely, compensated for by the superimposing gearbox. Despite the less direct gear ratio of the switching gearbox, the driver thus does not have to carry out a larger steering turning angle than under normal circumstances, in which the switching gearbox is in the energized state and the servo assistance is functioning. Because of this combination of the superimposed gearbox and the switching gearbox with the control of the gearbox described above, in the event of a failure of the electric servomotor, it is possible to both reduce the steering torque that the driver must generate and maintain the same steering wheel angle, despite the reduced steering torque. Advantageously, both the steering torque and the steering angle are maintained at values that correspond to the normal state, in which the electric servomotor is fully functional, by way of appropriate design of the switching and superimposing gearboxes, so that the driver does not notice any change in the steering behavior.

The switching gearbox is advantageously located between the superimposing gearbox, by way of which a superimposed steering angle can be specified, and the steering gearbox, by way of which the steering shaft is coupled to the steering linkage. It is also possible to integrate the switching gearbox into the superimposing gearbox in the steering shaft. The switching gearbox can advantageously be switched between exactly two gear ratios, which are associated with the energized state and the de-energized state of the switching actuator. Two gear ratios are generally sufficient because this covers the normal state, in which the electric servomotor is active, and emergencies, in which the electric servomotor has failed.

The switching gearbox is designed as a planetary gear system, for example, in which the input shaft is connected to a sun gear and the output shaft is connected to a ring gear, wherein the sun gear is rotatably connected to the ring gear by way of planet wheels and the planet wheels are held on a planet carrier. The planet carrier can be fixed so as to be stationary in the housing by way of the energized switching actuator or may revolve in the released, de-energized state. In this way, two different operating modes having differing gear ratios are implemented.

An electromagnetic actuator may, for example, be used as the switching actuator, which fixes a gearbox component so as to be stationary in the housing or releases the same. Under normal circumstances, when the servomotor is functioning, the switching actuator is activated and fixes the gearbox component. In an emergency, the actuator is de-energized and releases the gearbox component.

Optionally several switching actuators may be provided, which act on differing gearbox components of the switching gearbox and release or clamp the same. Advantageously two switching actuators are arranged, which are reciprocally open or closed in the de-energized state, such that a first switching actuator is designed to be open when de-energized and the second switching actuator is designed to be closed when de-energized, and the switching actuators take on corresponding reversed positions in the energized state. Designs as electromagnetic actuators are also possible, if several switching actuators are provided.

In the de-energized state, the superimposing gearbox is advantageously set so that the larger steering turning angle, which is created by the de-energized switching gearbox due to the less direct gearing, is compensated for by way of the superimposed steering angle.

Further advantages and advantageous embodiments will be apparent from the remaining claims, the description of the figures, and the drawings.

### BRIEF DESCRIPTION OF THE DRAWINGS

FIG. 1 shows an active steering system comprising a superimposing gearbox and a downstream switching gearbox in the steering shaft and further comprising an electric servomotor;

FIG. 2 shows a sectional view of a switching gearbox in a first embodiment; and

FIG. 3 shows a sectional view of a switching gearbox in a further embodiment.

### DESCRIPTION OF THE PREFERRED EMBODIMENTS

In the figures, identical components are denoted by the same reference numerals.

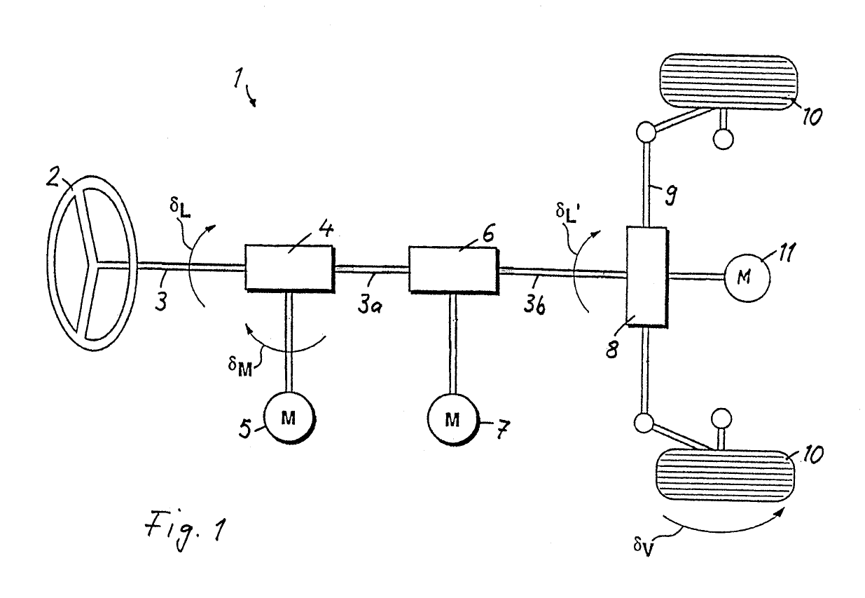

FIG. 1 shows an active steering system 1 for a vehicle, in which the driver specifies a steering angle δ_{L} via a steering wheel 2, and this is transmitted, via a steering shaft 3, a steering gearbox 8 and steering linkage 9, to the steerable front wheels 10, where a wheel steering angle δ_{V} is set. A superimposing gearbox 4, which can be adjusted by way of a servomotor 5, is integrated into the steering shaft. A superimposed steering angle δ_{M} can be generated in the superimposing gearbox 4, which is superimposed on the manual or steering angle δ_{L} specified by the driver, whereby an overall steering angle δ_{L}′ is additively set, and this is supplied to the steering gearbox 8 as the steering pinion angle. The superimposed steering angle δ_{M} depends on the actuation of the associated servomotor 5.

The steering gearbox 8 is associated with a servo or steering force assistance device 11, which is designed as an electric servomotor. Upon actuation of the servomotor 11, a supporting torque is introduced into the steering gearbox 8, so that the driver has to apply a lower manual or steering torque for the desired steering angle.

The steering system 1 is further equipped with a switching gearbox 6, which is associated with a switching actuator 7. The switching gearbox 6 is integrated into the steering shaft 3 and disposed between the superimposing gearbox 4 and the steering gearbox 8. The switching gearbox 6 can be used to modify the gear ratio in the transmission path between the steering wheel and the steerable wheels. This is particularly advantageous when the electric servomotor fails, for example as a result of a power failure, and thus no supporting steering torque can be generated. In this situation, the gear ratio can be changed to less direct gearing by appropriately actuating the switching gearbox 6 by way of the switching actuator 7, so that the driver has to generate only a comparatively low manual or steering torque, despite failed servo assistance, which is no higher, or only negligibly higher, than the steering torque that would have to be applied with servo assistance. In contrast, under normal circumstances, which is to say with the servo assistance functioning, a changed gear ratio is not set by the switching gear, and the gear ratio is 1:1. With less direct gearing, on the other hand, the gear ratio is at least 1:2, and preferably 1:4.

The switching gearbox 6 can preferably be switched back and forth between two different gear ratios by way of the switching actuator 7, which is to say between direct gearing having a gear ratio of 1:1 and indirect gearing having a gear ratio of at least 1:2, and preferably 1:4. The indirect gear ratio is advantageously set in the event of a de-energized switching actuator, while the direct gear ratio of 1:1 is in effect when the switching actuator 7 is activated. This ensures that the failing servo assistance is compensated for by the less direct gear ratio in the event of a failure of the onboard power system, which affects both the electric servomotor and the switching actuator.

The indirect gear ratio in the switching gearbox 6 is associated with an increased steering angle δ_{L}, which the driver must apply to set a desired wheel steering angle. So as to compensate for the increased steering angle, a superimposed steering angle δ_{M} can be generated by way of the superimposing gearbox 4, which modifies the steering angle ratio in such a way that the increased steering angle in the switching gearbox 6 is again reduced to the normal level. The driver thus only has to generate the manual or steering angle δ_{L} that would be required with an active servomotor 11 and with a direct gearing of 1:1 in the switching gearbox 6.

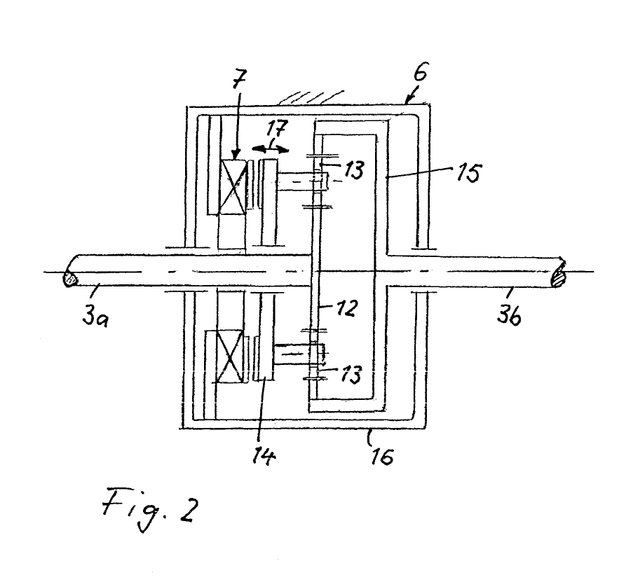

FIG. 2 shows the switching gearbox 6 having an integrated switching actuator 7. The switching gearbox 6 is designed as a planetary gear system and is connected at the input side to the steering shaft section 3a facing the superimposing gearbox 4, and at the output side to the steering shaft section 3b connected to the steering gearbox 8 (see also FIG. 1). The steering shaft section 3a on the input side is rigidly connected to a sun gear 12, which meshes with a ring gear 15 by way of planet wheels 13 on a planet carrier 14 and drives this ring gear, which is rigidly connected to the shaft section 3b located on the output side. All the gearbox components and the switching actuator 7 are disposed in a housing 16 of the gearbox.

The switching actuator 7 is designed as an electromechanical actuator and acts on the planet carrier 14, which is mounted axially displaceably in the housing 16 of the gearbox 6, in accordance with the double arrow 17. In the energized state, an attracting force acts on the planet carrier 14, so that the planet carrier 14 is drawn to make contact with a friction surface on the switching actuator 7 and rests against this surface. This holds the planet carrier 17 in a stationary manner in the housing. However, the planet wheels 13 remain in engagement with the sun gear 12 and the ring gear 15.

In the de-energized state, in contrast, no frictional contact exists between the planet carrier 14 and the friction surface on the switching actuator 7, so that the planet carrier 14 that is mounted rotatably in the housing 5 can revolve. The switching gearbox 6 can thus be switched between two different gear ratios, wherein a direct gear ratio of 1:1 is present when the switching actuator 7 is in the energized state, and a less direct gear ratio of 1:4 is provided when the switching actuator 7 is in the de-energized state, which is associated with a reduced manual or steering torque for the driver. The larger attendant steering angle can be compensated for by the superimposing gearbox 4, which is advantageously designed so that the superimposing gearbox 4 acts in a compensating manner when the servomotor 5 is de-energized, so that the driver does not have to apply a larger manual or steering angle δ_{L}, despite the less direct gear ratio in the switching gearbox 6.

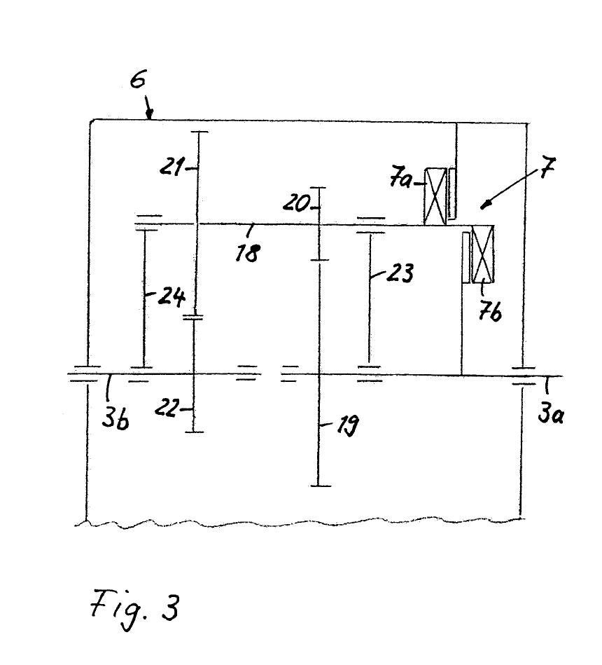

FIG. 3 shows a further exemplary embodiment comprising a switching gearbox 6 and an integrated switching actuator 7. The switching gearbox 6 comprises the steering shaft section 3a as the input shaft and the steering shaft section 3b as the output shaft. The switching actuator 7 comprises a total of two electromechanical actuators 7a, 7b, which are reciprocally open or closed when de-energized. The first switching actuator 7 is non-rotatably connected to a shaft 18, which is rotatably mounted in the gearbox housing and is disposed parallel to the input or output shaft 3a, 3b. The first switching actuator 7a is closed when de-energized, the bars 23 and 24 are fixedly provided for mounting the shaft 18, so that the shaft 18 is held in the housing in a stationary manner, but can rotate about the longitudinal axis thereof.

A second switching actuator 7b is located between the shaft 18 and the input shaft 3a; this switching actuator 7b is open when de-energized. A first gear wheel 19 is seated on the input shaft 3a and is engaged with a further gear wheel 20 on the shaft 18. Further gear wheels 21 and 22 are located parallel and offset on the shaft 18 and on the output shaft 3b and are engaged with each other. In the de-energized state, the gear wheels 19, 20, 21 and 22 translate the rotational movement from the input shaft 3a into the output shaft 3b with a gear ratio of i=1:x, with x being greater than 1 and assuming a value of 4 or greater, for example.

In the energized state, the first actuator 7a is open and the second actuator 7b is closed, which prevents relative movement between both the gear wheels 19 and 20 and the gear wheels 21 and 22. A gear ratio of i=1:1 is established between the input shaft 3a and the output shaft 3b.

### List of Reference Numerals

1 steering system
2 steering wheel
3 steering shaft
4 superimposing gearbox
5 servomotor
6 switching gearbox
7 switching actuator
8 steering gearbox
9 steering linkage
10 from wheel
11 servomotor
12 sun gear
13 planet wheel
14 planet carrier
15 ring gear
16 housing
17 double arrow
18 shaft
19 gear wheel
20 gear wheel
21 gear wheel
22 gear wheel
23 bar
24 bar
δ_{L} steering angle
δ_{M} superimposed steering an
δ_{V} wheel steering angle

1. A steering system in a vehicle comprising an electric servomotor for generating a servo torque supporting the steering motion, a switching gearbox comprising a switching actuator integrated in a steering shaft, wherein the gear ratio in the transmission path can be variably adjusted by way of the switching gearbox and has a less direct gear ratio when the switching actuator is de-energized than when it is energized.

2. The steering system according to claim 1, wherein the switching gearbox has a gear ratio of 1:1 in the energized state.

3. The steering system according to claim 1, wherein the switching gearbox has a gear ratio of at least 1:2, and preferably greater than or equal to 1:4, when de-energized.

4. A steering system according to claim 1, wherein a superimposing gearbox by way of which a superimposed steering angle (δ_{M}) can be superimposed on the steering angle (δ_{L}) specified by the driver is integrated into a steering shaft of the steering system.

5. The steering system according to claim 4, wherein the switching gearbox is disposed between the superimposing gearbox in the steering shaft and the steering gearbox.

6. The steering system according to claim 4, wherein the switching gearbox is integrated into the superimposing gearbox in the steering shaft.

7. A steering system according to claim 4, wherein the changed gear ratio of the de-energized switching gearbox can be compensated for by way of the superimposing gearbox,

8. A steering system according to claim 1, wherein the switching gearbox can be switched between exactly two gear ratios which are associated with the energized state and the de-energized state of the switching actuator.

9. A steering system according to claim 1, wherein the switching gearbox is designed as a planetary gear system.

10. A steering system according to claim 1, wherein the switching actuator comprises at least one electromagnetic actuator which fixes a gearbox component so as to be stationary in the housing or releases the same.

11. A steering system according to claim 1, wherein two switching actuators are provided, which fix the different gearbox components so as to be stationary in the housing, or release the same, and which are reciprocally open or closed when de-energized.

12. A method for operating a steering system according to claim 1, wherein the gear ratio is changed by de-energizing the switching gearbox in the event of a failure of the electric servomotor.

13. The method according to claim 12, wherein the changed gear ratio is compensated for by the superimposing gearbox.
